(19) United States
(12) Patent Application Publication
(10) Pub. No.: US 2023/0386163 A1
(43) Pub. Date: Nov. 30, 2023

(54) Object Level Data Augmentation Scheme for Training Object Detectors

(71) Applicant: Orbital Insight, Inc., Palo Alto, CA (US)

(72) Inventor: Wencheng Wu, Palo Alto, CA (US)

(21) Appl. No.: 17/827,660

(22) Filed: May 28, 2022

(51) Int. Cl. G06V 10/25; G06V 10/75; G06V 20/17; G06T 7/62

(52) U.S. Cl. CPC G06V 10/25; G06V 10/751; G06V 20/17; G06T 7/62

(57) ABSTRACT

An object identification system accesses a first ground truth image comprising an object of interest. The object identification system determines a relative size of the object of interest based on a comparison of a size of the object of interest to an overall size of the first ground truth image. In response to determining that the relative size of the object of interest does not exceed the threshold size, the object identification system generates a synthetic image by copying the OI into a second ground truth image, the second ground truth image different from the first ground truth image. The object identification system updates a training dataset of images with the synthetic image, wherein the training dataset is applied to train a machine-learned model to identify the OI in an image of a test dataset.

### TECHNICAL FIELD

This disclosure relates generally to machine-learned models trained to detect objects in an image and, in particular, to augmenting training data for training a machine-learned model to detect objects in an image.

### BACKGROUND

Training a machine-learned model requires a large volume of labeled training data to train the model. Accordingly, conventional techniques are directed towards augmenting training datasets by applying object-level data augmentation techniques to generate additional images to be included in the training dataset. However, conventional approaches to object-level data augmentation fail to consider the resolution of individual objects within an image. Additionally, these conventional approaches add objects from one image into another randomly without consideration as to the unnaturalness of the augmented objects. However, models trained on these crudely augmented images are inaccurate and ineffective when applied to identify objects in an image. Accordingly, there exists a need for a technique for augmenting training datasets through resolution-aware object-level data augmentation to improve the accuracy and performance of a machine-learned model trained using the training dataset.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

Figure (FIG. 1 illustrates an example system for applying object identification models to images captured by an imaging device, in accordance with an embodiment.

FIG. 2 is a block diagram illustrating a system architecture for an object identification system, in accordance with an embodiment.

FIG. 3 is an example flowchart for applying object jittering techniques to generate synthetic images for augmenting a training dataset, in accordance with an embodiment.

FIG. 4A illustrates an example ground truth image containing a large object of interest, in accordance with an embodiment.

FIG. 4B illustrates an example synthetic image generated by augmenting the second ground truth image with the large object of interest, in accordance with an embodiment.

FIG. 5A illustrates an example first ground truth image containing multiple small objects of interest, in accordance with an embodiment.

FIG. 5B illustrates an example second ground truth image sharing contextual features with the first ground truth image, in accordance with an embodiment.

FIG. 5C illustrates an example synthetic ground truth image generated by augmenting the second ground truth image with the one or more small objects of interest from the first ground truth image, in accordance with an embodiment.

FIG. 6 is an example flowchart for applying mask jittering techniques to generate synthetic images for augmenting a training dataset, in accordance with an embodiment.

FIG. 7A illustrates an example ground truth image containing multiple small objects of interest, in accordance with an embodiment.

FIG. 7B illustrates an example synthetic ground truth image generated by altering a mask label for one or more of the small objects of interest from the ground truth image, in accordance with an embodiment.

FIG. 8 is a block diagram illustrating components of an example machine able to read instructions from a machine-readable medium and execute them in a processor or controller, in accordance with an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed by way of example embodiments are systems, methods and/or computer program products (e.g., a non-transitory computer readable storage media that stores instructions executable by one or more processing units) for a system for object level data augmentation using images in a training dataset.

In one example embodiment, an object identification system trains and applies a machine-learned object identification model(s) to images captured by an aerial or surveying imaging device. The object identification system accesses a first ground truth image comprising an object (also referred to as a “rendered object”). The object identification system determines a relative size of the object based on a comparison of a size of the object to a size of the ground truth image. The object identification system determines whether the relative size of the object satisfies a threshold.

If the relative size of the object does satisfy the threshold, the object identification system generates a synthetic or augmenting image or image segment by adding the rendered object into a second ground truth image. The object identification system updates a training dataset of images with the synthetic image, such that the updated training dataset may be applied to train a machine-learned model to identify the object in images of a test dataset. If one or more of the relative size, resolution, or placement of the object do not satisfy the threshold, the object identification system generates a synthetic image by shifting the object to a different position within the first ground truth image.

In another embodiment, the object identification system accesses a ground truth image and identifies one or more objects within the ground truth image using one or more suitable computer vision techniques (described below). Within the ground truth image, each identified object is outlined by a bounding box manually defined by an operator. Accordingly, the object identification system generates a synthetic image by adjusting points on the bounding box of an identified object within the ground truth image to generate a new bounding box around the object. The object identification system updates the training dataset of images with the synthetic images.

### Example System Environment

Figure (FIG. 1 illustrates an example system for applying object identification models to images captured by an imaging device, in accordance with an embodiment. The example system environment shown in FIG. 1 may include an aerial imaging device 110 to capture sensor data of an area of interest (AOI) 120 and an object identification system 130, which identifies objects within the sensor data captured for the geographic region.

The aerial imaging device 110 is a device that captures imaging data, such as photos in the visible, infrared, ultraviolet or other light spectrums, regarding the area of interest 120. In one embodiment, the aerial imaging device 110 is a satellite, drone, helicopter, airplane, or other device capable of positioning itself at an elevation that is higher than the AOI 120. The aerial imaging device 110 further includes an imaging system, with one or more imaging sensors capable of capturing images of the AOI 120. If the aerial imaging device 110 has multiple imaging sensors, each may capture electromagnetic (EM) radiation in a different range of wavelengths (e.g., green, blue, red, infrared, or millimeter wavelengths).

While the aerial imaging device 110 is referred to herein as an aerial imaging device, it may capture any type of sensor data regarding the AOI 120 and is not limited to sensor data in the visible spectrum. The sensor data may include any electromagnetic, sound, vibration, chemical, particle, or other data regarding any characteristics or environment of the AOI 120 that may be captured using a computing device, machine, or other electro-mechanical component, such as a accelerometer, camera, microphone, moisture sensor, etc. Furthermore, the aerial imaging device 110, although shown to be located at a position higher in elevation relative to the AOI 120, in other embodiments the aerial imaging device 110 may gather the sensor data for the AOI at different elevations or positions including, but not limited to, angle positions relative to the AOI 120, such as below the AOI 120 in elevation, at the same elevation as the AOI 120, and so on. For example, the aerial imaging device 110 may be a surface-based scanner, such as a LIDAR, radar imaging, or other scanning device, such as a sensor/imaging device located on a mobile platform such as a car that captures data regarding an AOI while driving by or through the AOI.

The area of interest (AOI) 120 is an area on a land surface (e.g., the surface of the Earth), and all features (natural and man-made) within that area. In some embodiments, the AOI may be a volume associated with a land surface, for example the spatial volume regions of the Earth and all features (natural and man-made) within that volume. The AOI 120 may be defined by a closed boundary on the land surface. The closed boundary itself may be defined using various connected geographic markers, which may be indicated using geographic coordinates, such as longitude and latitude indicators. Alternatively, the AOI 120 may be defined by a set of vectors describing the closed boundary. In some cases, the AOI 120 may be defined using multiple closed boundaries, with each closed boundary defined using one of the methods noted above. The AOI 120 may also have within one of its closed boundaries an excluded area(s) or volume(s). These excluded areas may also be defined using closed boundaries and are specified in a similar fashion. In another embodiment, the AOI 120 is defined using a cartographical indicator, i.e., a commonly, conventionally, administratively, or legally agreed upon indicator of a bounded area on a land surface. For example, these cartographic indicators may include a point of interest, landmark, address, postal code, city/town/village, metropolitan area, country, province/county, neighborhood, unincorporated area, and so on. For example, the AOI 120 may be indicated using a postal code, which is defined by a postal service of a country. The granularity of an image of the AOI 120 captured by the may vary depending on parameters defined by an operator, capabilities of the aeriel imaging device 110, or a combination thereof. For example, an image may capture a parking lot of a shopping center or capture a more expansive highway.

The aerial imaging device 110 transmits captured images of an AOI 120 to the object identification system 130 via the network 140. The aerial imaging device 110 may also transmit metadata along with each set of sensor data describing any captured images. This metadata may include the time of capture of the sensor data, the geographic location (e.g., identified by geographic coordinates) of the captured images, including the geographic boundaries corresponding to the borders of the captured images, range of wavelengths captured, shutter speed, aperture size, focal length, field of view, resolution, number of pixels, etc. The captured images and associated metadata may be transmitted to an intermediary, such as a satellite imagery provider, or storage device before being transmitted to the object identification system 130.

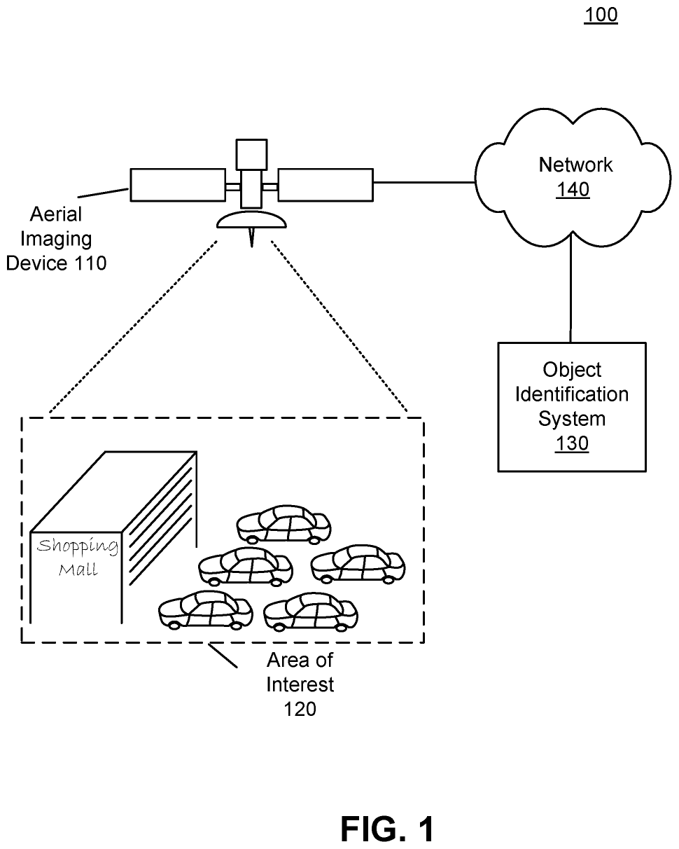

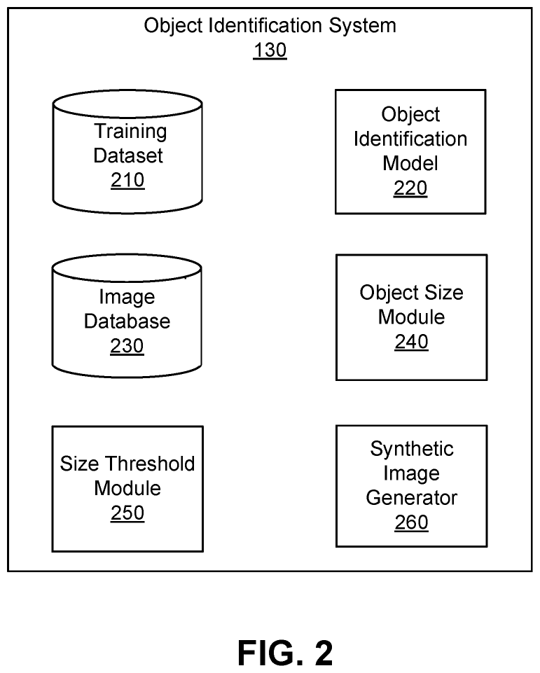

The object identification system 130 receives and stores sensor data and metadata transmitted from the aerial imaging device 110. For the sake of explanation, sensor data is hereafter described with reference to the object identification system 130 as “images,” but a person having ordinary skill in the art would appreciate that the techniques described below may be applied to any of the aforementioned types of sensor data. The object identification system 130 additionally stores object identification models, machine-learned models trained to identify particular types of objects present in an image. As described herein, object identification models may also be referred to as object detectors. The object identification system 130 further stores training datasets upon which the object identification models are trained. As will be discussed below, the accuracy of an object identification model depends on the robustness of the dataset on which it is trained. However, the volume of images or data upon which the detectors may be trained may be limited. Accordingly, the object identification system 130 implements a combination of techniques to generate synthetic images to augment an existing training dataset upon which an object identification model is trained. The object identification system 130 is further described below with reference to FIGS. 2-5.

Interactions between the aerial imaging device 110 and the object identification system 130 are typically performed via the network 140, which enables communication between the aerial imaging device 110 and the object identification system 130. In one embodiment, the network 140 uses standard communication technologies and/or protocols including, but not limited to, links using technologies such as Ethernet, 600.11, worldwide interoperability for microwave access (WiMAX), 3G, 4G, LTE, digital subscriber line (DSL), asynchronous transfer mode (ATM), InfiniBand, and PCI Express Advanced Switching. The network 140 may also utilize dedicated, custom, or private communication links. The network 140 may comprise any combination of local area and/or wide area networks, using both wired and wireless communication systems.

### Object Level Data Augmentation

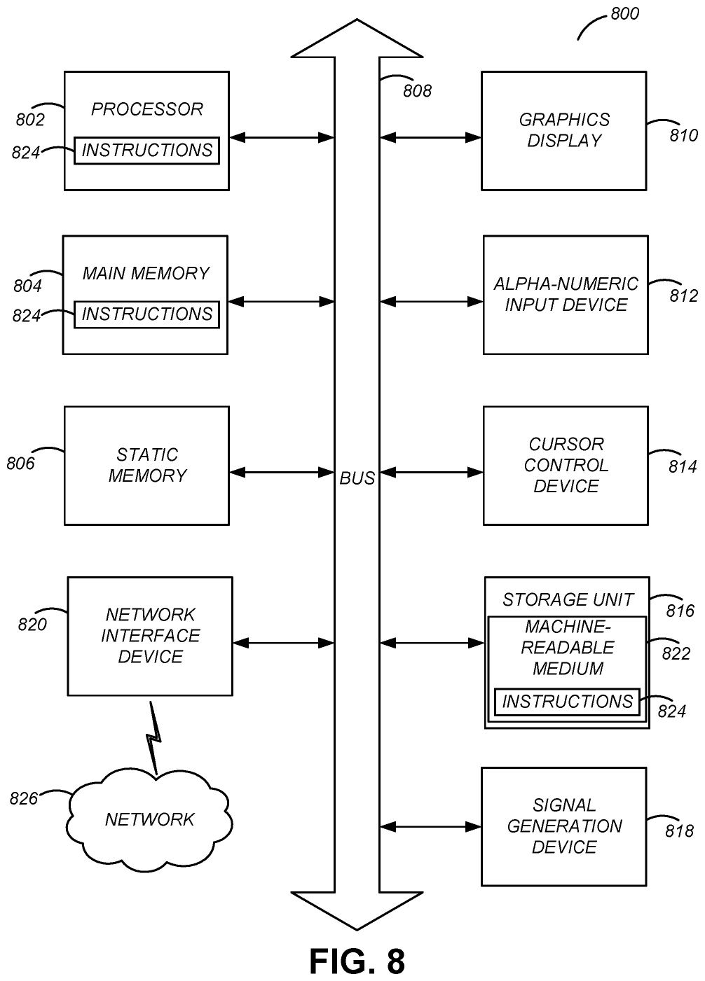

FIG. 2 is a block diagram of the system architecture for the object identification system 130, in accordance with an embodiment. The object identification system 130 illustrated in FIG. 2 includes an object identifier training dataset 210, an object identification model 220, a ground truth image database 230, an object size module 240, a size threshold module 250, and a synthetic image generator 260. However, in other embodiments, the object identification system 130 may include different and/or additional components. For example, the modules (e.g., 240, 250), models (e.g., 220) and generators (e.g., 260) described in the specification, including with FIG. 2, may be embodied through computer program code (e.g., comprised of instructions) having functionality are described herein and that may be stored in a non-transitory computer readable storage medium and executable by at least one processor, for example, the storage medium and processor described with FIG. 8.

The object identification system 130 illustrated in FIG. 2 includes a ground truth image database 230, an object size module 240, a size threshold module 250, a synthetic image generator 260, an object identifier training dataset 210, and an object identification module 260. However, in other embodiments, the object identification system 130 may include different and/or additional components.

The object identifier training dataset 210 stores a large volume of images recorded by aerial imaging devices 110 for a number of AOI's. Each entry of the object identifier training dataset is an image of a scene (e.g., conditions in an AOI at a particular time) labeled with objects present in the scene. As described herein, a “label” is generally a verbal description (e.g. words, icons, characters, numbers indicating the position of points etc.) of an object within an image. Labels stored in the object identifier training dataset 210 describe an object using any suitable mechanism including, but not limited to, a polygon outlining the location or shape of the object in an image, or a verbal label provided by an operator. Each entry in the training dataset 210 may further include attributes of the image relevant to identifying the object including, but not limited to, visual features of each object itself and the area surrounding the object. An object identification model or operator may rely on such attributes to determine a label assigned to the object.

The object identification system 130 may receive attributes extracted from an image and generate a component vector for the image. A component vector is a representation of the attributes extracted from an image (e.g., a feature vector), which may be processed by a machine-learning model to identify objects within the image. As described herein, such a feature vector is referred to as a “component vector.” To that end, the object identification system 130 analyzes attributes extracted from an image to generate components of the image, which in aggregate comprise a component vector. “Components” represent attributes extracted from an image to be input to a machine learning model to identify objects within an image. Described differently, components are numerical representations of the various attributes of an image to be processed by an object identification model to identify one or more objects in an image. During training, an object identification model determines parameter values for each component input to the model by analyzing and recognizing correlations between the components associated with an object and the label assigned to the object. As described herein, “parameter values” describe the weight associated with each component of an image.

Each entry in the object identifier training dataset 210 further includes a unique identifier of the AOI mapped to a time at which the image was recorded. Accordingly, the object identifier training dataset 210 may include labeled training data corresponding to the same AOI at various times and similar AOI's at different times. The object identifier training dataset 210 may further be categorized into datasets of images capturing particular types of objects, for example a first dataset of images capturing boats or particular types of boats, a second dataset of images capturing planes or particular types of planes, and a third dataset of images capturing cars or particular types of cars. Each dataset may be used to train an object identification model to identify different objects or types of objects. Each training dataset may also be used to train multiple object identification models, where each object identification model is trained to identify a particular object or type of object.

Accordingly, “training” an object identification model refers to the process of utilizing machine learning techniques to derive a model (or model wrights) that is capable of receiving an image as an input and outputting predicted descriptions for objects in the said image. Training an object identification model requires a dataset of images labeled with a corresponding ground-truth information. The dataset of images may additionally include object-level augmented images and their corresponding object-level augmented ground-truth information, using the techniques described herein. Any suitable technique for training an object identification model may be applied including, but not limited to, methods such as FasterRCNN, YOLO, MaskRCNN etc. By applying such training methods to a dataset of images comprising synthetic images generated using the object-level augmentation techniques described herein to improve its accuracy via providing more variety and samples to the model during training.

As labels are assigned to objects in an image, the object identification system 130 may update the object identifier training dataset 210 with images received from the aerial imaging device 110 during a recent time period. Accordingly, the object identification system 130 may iteratively train an object identification model based on updated data in the object identifier training dataset 210 to continuously improve the accuracy of predictions generated by the object identification model. As described herein, iterative training of the object identification model refers to the re-training of the model at periodic intervals, in response to a triggering event, or both. By iteratively training the model based on components extracted from updated entries in the training dataset 210, the object identification model continues to learn and refine its parameter values based on new and updated data. Iteratively re-training the object identification model in the manner discussed above allows the model to more accurately identify an object(s) in an image.

The object identification model 220 applies machine-learning techniques to an image to identify objects within the image based on a combination of attributes extracted from the image. To identify objects in an image, the object identification model 220 may be a mathematical function or other more complex logical structure, trained using a combination of attributes stored in the training data store 260 to determine a set of parameter values stored in advance and used as part of the object identification analysis. As described herein, the term “model” refers to the result of the machine learning training process described above. Examples of an object identification model include, but are not limited to, a neural network, regression model, or PCA (principal component analysis).

The ground truth image database 230 maintains images captured by the aerial imaging device 110 containing objects that have been manually labeled by an operator. As described herein, such an image is referred to as a “ground truth image” (GTI). Additionally, a “label” is a description of an object in an image. Labels stored in the ground truth image database 230 describe an object using any suitable mechanism including, but not limited to, a polygon outlining the location or shape of the object in the GTI or a verbal label defined by an operator. For example, the aerial imaging device 110 may capture an image of a dock with several boats and an operator may manually label each boat within the image. As described herein, an operator may label an object by identifying the object itself, for example using polygon or a bounding box surrounding the object. Because an object within such a polygon (or bounding box) is often represented by a matrix of binary labels describing whether a pixel is inside the polygon or outside, the polygon (or bounding box) is hereafter referred to as a “mask label” of the object. As described herein, a mask label may also be referred to as a “synthetic image-label pair.” Additionally, an operator may define errors or inconsistencies within a manual label for an object. The ground truth image database 230 stores the captured image of the pier with the labels of each boat. The ground truth image database 230 may be updated with newly captured and labeled images periodically. Alternatively, the ground truth image database 230 may be updated in response to a transmission from the aerial imaging device 110 or an input from an operator.

Object identification systems, such as the object identification system 130 implement three basic techniques for generating synthetic images to be added to a training dataset, for example the object identifier training dataset 210. First, a system may identify an object in a first GTI and copy the object into a random position in a second GTI, creating a third, synthetic image. Accordingly, the robustness of the training dataset may be increased by generating synthetic images and updating the training dataset with such synthetic images. Second, a system may generate a synthetic image by editing the placement of an object in a GTI, for example by moving the object from position in a GTI to another position in the same GTI, for example a translation, rotation, or combination thereof. Third, a system may generate synthetic images by accessing a labeled object stored in a database, such as the ground truth image database 230, and copy the accessed object into a GTI. Such labeled objects may be extracted from stored GTI's but are stored in the database independent of any GTI. In embodiments where a GTI contains multiple OI's, for example n OI's, the object size module 240 may randomly select up to n objects from the GTI to be copied into a second GTI. Here too, each of the n objects copied into the second GTI may undergo a random distortion in the second GTI, for example a rotation, a scaling in the either an x-direction, a y-direction, or both, an alteration in color and/or contrast, an adjustment in aspect ratio, a shift in positioning, or any other relevant adjustment, or a combination thereof. However, in conventional systems, the random placement of the object in the second GTI or the new position of the object in the same GTI is random, which reduces the usefulness in the generated synthetic images when training an object identification model, for example the object identification model 220. In addition to its random placement, an object copied into a second GTI undergoes a random distortion, which affects the orientation or scale of the object within the second GTI. For example, an object copied into a GTI may be randomly scaled by 10%, randomly rotated 45 degrees before, or a combination thereof.

While some objects may still be easily detectable and recognizable by the object identification model 220 when randomly placed in a new GTI, other objects may not be. Consider, for example, a GTI of an airplane on a runway. Visual characteristics of the airplane (i.e., an object within the image) alone may be sufficient for the object identification model 220 to identify the airplane regardless of the environment or context it is in. Accordingly, the object identification model 220 is capable of detecting the airplane even in an unrelated environment of a second GTI such as a jungle. In contrast, consider a GTI of parked cars in a parking lot. The visual characteristics of an individual car (i.e., an object within the image) alone may be insufficient for the object identification model 220 to identify a parked car because other objects in the image may be easily confused with the parked car. For example, other objects may follow similar orientations or shapes to the parked cars. Accordingly, beyond the visual characteristics of a car, contextual features regarding the car distinguish the car from other objects in the GTI. For example, cars in the parking lot should be lined up in a particular orientation or pattern, must be oriented in the direction of the road, or must be positioned in the portion of the GTI corresponding to the parking lot rather than a building. Accordingly, to accurately detect the objects in such a GTI, the object identification model 220 must identify additional contextual features surrounding the object, which are lost when the object is randomly positioned in a new image.

To accommodate these two categories of objects, the object size module 240 determines and categorizes an “object of interest” (OI) based on the relative size of the OI. As described herein, the relative size of an object is measured based on the resolution of the image. In one embodiment, OI size module 220 determines the relative size of an OI is determined by a comparison of a size of the OI to an overall size of the GTI. The object size module 240 may determine the overall size of the GTI based on a total number of pixels in the GTI. The object size module 240 may determine the size of the OI based on a number of pixels that the OI covers within the GTI. Accordingly, the object size module 240 may determine the relative size of the OI based on a ratio of the number of pixels that the OI covers within the GTI to the total number of pixels that the OI covers within the GTI.

In some embodiments, the object size module 240 determines the relative size of each OI in a GTI. In alternate embodiments, the object size module 240 determines the relative size of a particular OI in a GTI identified by an operator or each OI of a particular type identified by an operator, for example “boats.” The object size module 240 may be applied to process each GTI stored in the database 230. In some embodiments where the ground truth database store 210 may maintain a set of labeled, independent OIs, stored independent of any image, the object size module 240 may determine the size of each independent OI.

The size threshold module 250 compares the relative size of an OI (as determined by the object size module 240) to a threshold size to determine whether relative size of the OI satisfies the threshold. As described herein, the threshold against which the relative size is compared is a threshold number of pixels, for example 10 pixels or 20 pixels. The threshold size may be characterized by a number of pixels in two dimensions, for example height and width. In some embodiments, the size threshold module 250 determines the threshold number of pixels based on the overall size of a GTI. In such embodiments, the size threshold module 250 may compare OIs in a GTI with a larger overall size against a higher threshold than OIs in a GTI with a smaller overall size.

In some embodiments, the size threshold module 250 determines the threshold size (e.g., the number of pixels within the object) based on the input size of the object identification model 220. The object identification model 130 may resize each GTI to a fixed input before training the object identification model 220. Such a technique is referred to as “resize preprocessing.” In implementations involving resize preprocessing, the size threshold module 250 may compare OIs in a GTI with a larger overall size against a lower threshold than OIs in a GTI with a smaller overall size. Alternatively, the object identification model 130 may crop each GTI to a fixed input image size before training the object identification model 220. Such a technique is referred as “crop preprocessing.” In implementations involving crop preprocessing, the size threshold module 250 may compare OIs in a GTI with a larger overall size against the same threshold as the OIs in a GTI with a smaller overall size. In an example embodiment involving resize preprocessing, the size threshold module 250 defines the threshold as 0.05 (5%) relative to the size of each GTI. The size threshold, characterized in units of pixels, varies depending on the size of each GTI. In an example embodiment involving crop preprocessing, the size threshold module 250 may define the threshold as 0.05 (5%) relative to the input size of the object identification model 220. In such embodiments, the threshold is constant regardless of the size of each GTI

Recalling the third technique of generating a synthetic image by copying an independent object from the database 230 into a GTI, the size threshold module 250 may compare the size of the independent OI against a default threshold. The size threshold module 250 may determine the default threshold based on an average, median, or any other statistically relevant measurement determined from previous threshold determination. In an embodiment where the aerial imaging device 110 is a satellite operating at a fixed distance from the surface, each pixel in a GTI captured by the aerial imaging device 110 may represent a physical dimension of 0.5 meters. In such an embodiment, the threshold may be defined as 6 pixels, or 3.0 meters.

The size threshold module 250 compares the relative size of an OI to a threshold size to identify a technique most suitable for generating a synthetic image using the OI. If the size threshold module 250 determines that the relative size of the OI satisfies the threshold (e.g., is greater than the threshold), the synthetic image generator 260 may generate a synthetic image by copying the OI into a second GTI at a random position and orientation. Synthetic images may be generated automatically using the techniques described herein or manually by an operator. Where generated manually by the operator, the synthetic image generator 260 may provide the operator with a graphical user interface offering the functionality necessary to generate a synthetic image, for example a dataset of images and objects of interest.

In one embodiment, the synthetic image generator 260 accesses a second GTI and copies the OI from the first GTI into a second at any position within the second GTI. Additionally, the synthetic image generator 260 may copy the OI at any orientation relative to the second GTI. For example, where an OI is an airplane and the second GTI captures a scene of an airport next to a body of water, the synthetic image generator 260 may copy the OI (i.e., the airplane) into any position on second GTI including the body of water. Positioning of the OI in the body of water will not impact the ability of the object identification model 220 to identify the OI as an airplane because the relative size of the OI is sufficient for the object identification model 220 to identify the OI based only on its own visual features. In another embodiment, the synthetic image generator 260 transitions the OI to a different, random position within the same GTI. For example, where an OI is an airplane and the GTI captures a scene of an airport next to a body of water, the synthetic image generator 260 may copy the OI of the airplane into any position in the body of water. Again, positioning the OI in the body of water, or more specifically the corresponding pixels within the i mage representing the body of water, will not impact the ability of the object identification model 220 to identify the OI as an airplane because the relative size of OI is sufficient for the object identification model 220 to identify the OI based only on its own visual features. In yet another embodiment, the synthetic image generator 260 may access a GTI and an independent OI from the ground truth database 230 and copy the OI at any position within the GTI. For example, where the accessed OI (i.e., an airplane) and the accessed GTI captures a scene of a body of water, the synthetic image generator 260 may copy the OI at any position on the accessed GTI. Again, positioning the OI in the body of water will not impact the ability of the object identification model 220 to identify the OI as an airplane because the relative size of OI is sufficient for the object identification model 220 to identify the OI based only on its own visual features.

As described herein, the synthetic image generator 260 may “copy” an OI into a GTI by applying a stitching operation, a blending operation, a layering operation, or any combination thereof to seamlessly integrate the copied OI into the scene of the GTI. In some embodiments, the synthetic image generator 260 applies different operations to different groups or subsets of pixels of the copied OI. For example, the synthetic image generator 260 may apply a blending operation to seamlessly boundary pixels of the copied OI into the scene of the GTI, while applying a pixel replacement operation to interior pixels of the copied OI to replace the pixels of the scene of the GTI at the location where the copied OI is placed within the GTI. Furthermore, the synthetic image generator 260 may apply a rescaling operation, a rotation operation, a contrast adjustment operation, or any combination thereof to the copied OI before integrating the copied OI into the scene of the GTI. As described herein, such techniques implemented by the synthetic image generator 260 for generating synthetic images may be collectively referred to as “random-copy-and-paste” techniques.

If the size threshold module 250 determines that the relative size of the OI does not exceed the threshold (e.g., is equal to or below the threshold), the synthetic image generator 260 may generate synthetic images using multiple object augmentation techniques. Using a first set of techniques, referred to as “context-preserving techniques,” the synthetic image generator 260 may further analyze the ground truth image to extract additional information or visual details characterizing the context of the OI in the GTI and generates a synthetic image by modifying the image data of the same or another GTI to copy the OI based on the extracted contextual information or visual details. Using a second set of techniques, referred to as “mask jittering techniques,” the synthetic image generator 260 generates a synthetic image by altering the mask label of an object(s) within a GTI without modifying the image data of any GTI or copying the object into any GTI. Both context-preserving techniques and mask jittering techniques are further described below.

As described herein, techniques implemented by the synthetic image generator 260 for generating synthetic images using contextual features are collectively referred to as “context-preserving techniques.” In a GTI where two distinct types of objects appear visually similar or the object identification model 220 may be unable to distinguish the two types of objects based on their features in the GTI, the synthetic image generator 260 may additionally consider such visual features characterizing the context surrounding each object when generating a synthetic image.

In contrast to the random-copy-and-paste techniques where an OI may be copied independent of contextual features, the synthetic image generator 260 may apply context-preserving techniques to leverage the insights extracted from contextual features to guide the copying of an OI. Context-preserving techniques are further discussed below. For example, in an aerial image of a parking lot, a car in the parking lot may appear visually similar to an A/C unit on a building top (e.g., both objects appear rectangularly shaped). Parking lot lines on either side of an object indicate that the OI is a car and not an A/C unit. Additionally, traffic features such as a crosswalk, turn signs painted on the road, or any other visual features characteristic of a road may indicate that the OI is a car and not an A/C unit or any other visually similar object. In comparison, a chimney or other feature of a rooftop located in proximity to an OI may indicate that the OI is an A/C unit and not a car. Additionally, the arrangement and number of cars in the parking lot may differ from the arrangement and number of A/C units on the roof. Thus, the arrangement and the number of of candidate objects (i.e., objects resembling cars) in the scene may be indicative of whether an OI is a car, an AC, or any other visually similar object.

To extract contextual features from a GTI, the synthetic image generator 260 may apply computer vision techniques, for example optical character recognition, image analysis techniques, image processing algorithms, semantic segmentation algorithms, or a combination thereof. For example, the synthetic image generator 260 may implement image analysis techniques to analyze the arrangement of OI's in the GTI, the number of OI's in the GTI, the color and texture of the background where OI's are positioned in the GTI, the relative position OI's to various other objects (e.g., lines in the parking lot, light poles, traffic marks, booths, etc.) in the training data, Examples of image processing algorithms include, but are not limited to, template matching, line detection, orientation detection, image matching, image or patch retrieval, etc. The synthetic image generator 260 may implement segmentation algorithms to identify relevant scene contextual information such as road, parking areas, building, body of water, etc.

Additionally, the synthetic image generator 260 does not copy objects that do not satisfy the threshold size to a random position of the same GTI. Continuing from the example of the GTI capturing a parking lot, the object identification model 220 would still be unable to identify the OI (e.g., a car in the parking lot) if it were copied into a second GTI capturing a scene of the jungle because the second GTI lacks the contextual features based on which the object identification model 220 identified the object in the first GTI. Accordingly, a synthetic image generated by copying the OI (e.g., the car in the parking lot) into the second GTI (e.g., the scene of the jungle) would not improve the performance of the object identification model 220.

Accordingly, the synthetic image generator 260 may search the ground truth image database 230 for a second GTI containing at least one or more of the extracted contextual features. To identify the second GTI, the synthetic image generator 260 may apply one or more of the computer vision techniques discussed above to identify a second GTI containing at least one of the extracted contextual features. Returning to the example above of an OI copied from a GTI of a parking lot, the synthetic image generator 260 extracted contextual features such as parking lot lines from the image to further characterize OI's in the image representing cars. Accordingly, the synthetic image generator 260 searches the ground truth image database 230 for additional GTI's containing parking lot lines. The synthetic image generator 260 may select one or more of the additional GTI's for copying the OI. Accordingly, depending on the number of selected additional GTI's, the synthetic image generator 260 may generate multiple synthetic images from a single OI.

To generate the synthetic image from a second GTI found in the database 230 and an OI identified in the first GTI, the synthetic image generator identifies the position of the contextual features within the second GTI and copies the OI at a position relative to the contextual features. For example, using image processing techniques and image analysis algorithms, the synthetic image generator 260 identifies the gaps in a row of a parking lot (e.g., empty spots in a parking lot) in a row of the parking lot based on labels of OIs in the second GTI and recognizes the gaps as candidate positions for a copied OI. As another example, the synthetic image generator 260 identifies candidate positions for copied OIs based on contextual features enclosing or surrounding a copied OI (e.g., lines in the parking lots indicating parking stalls for cars) and the determination that there is currently no OI positioned within the identified gaps. As yet another example, the synthetic image generator 260 additionally implements metadata analysis of digital maps to identify candidate positions for the copied OI based on the contextual information jointly extracted from the digital map and the second GTI and the expected arrangement of the copied OI (e.g., the identification of parking regions in the second GTI based on the alignment of a digital map and GTI image data and the expected placement and orientation of objects based on the metadata in the digital map).

The synthetic image generator 260 may align the OI according to the position and orientation of the contextual features or based on a known proximal relationship with the contextual features. For example, the synthetic image generator 260 may implement image processing and image analysis algorithms to determine the range of spacing between OI's (copied OI's from the first GTI and existing OIs in the second GTI), the range of orientations of copied OI's based on the spacing pattern and orientation range derived from a row of the existing OIs in the second GTI. The synthetic image generator 260 may additionally derive a known proximal relationship with the contextual features directly from metadata such as metadata stored within a digital map associated with the second GTI. and/or from common knowledge of the size of the OI's and the typical spacing between them. For example, cars are typically parked about 1 foot apart on either side). The synthetic image generator 260 may additionally derive a known proximal relationship with the contextual features may from the common knowledge related to the reference contextual features. For example, cars parked within the lines of a parking stall have a higher probability of being located in the center of the parking spot than off the center).

Returning to the example above of an OI copied from a GTI of a parking lot, the synthetic image generator copies the OI into the second GTI of a parking lot by aligning the OI with the parking lot lines identified in the second GTI. A car (i.e., the OI copied from the first GTI) would not be parked perpendicular to a set of parking lot lines, between two sets of parking lot lines, or outside of any set of parking lines. Rather, the car must be parked parallel to but within a pair of adjacent parking lot lines. Accordingly, the synthetic image 240 copies the car into positions of the second GTI in alignment with the identified parking lot lines.

In some embodiments, the second GTI may include multiple instances of contextual features, which create multiple eligible positions for the synthetic generator to copy the OI. In such embodiments, the synthetic image generator 260 may generate numerous synthetic images by copying the OI at any permutation of eligible positions within the second GTI. In embodiments where a GTI contains multiple eligible positions, for example n eligible positions, the synthetic image generator 260 may randomly select up to n positions in the GTI to copy the OI. For example, in a second GTI containing three eligible positions, the synthetic image generator 260 may generate up to 7 synthetic images from a single OI: one with the OI positioned at the first eligible position, one with the OI positioned at the second eligible position, one with the OI positioned at the third eligible position, one with an OI positioned at the first and second eligible positions, one with an OI positioned at the first and third eligible positions, one with an OI positioned at the second and third eligible positions, and one with an OI positioned at the first, second, and third eligible positions.

The synthetic image generator 260 may generate a synthetic image by applying the techniques discussed above to copy an OI stored in the ground truth image database 230 independent of a GTI into a GTI accessed from the ground truth image database 230. The ground truth image database 230 may store such objects in association with relevant contextual features for identifying each object. In one embodiment, the ground truth image database 230 is organized into lookup tables for mapping particular objects to the contextual features relevant for identifying the objects. Continuing from the example discussed above, the ground truth image database 230 may store an object representing a car with a mapping to contextual features such as traffic features and/or parking lot lines. Accordingly, the synthetic image generator 260 may lookup contextual features for an OI directly in the ground truth image database as an alternative to or in addition to extracting contextual features from an image. After identifying a GTI that contains the contextual features, the synthetic image generator 260 applies the techniques discussed above to appropriately position the OI relative to the context feature. For example, where the synthetic image generator 260 copies a car into a GTI, the synthetic image generator 260 identifies parking lot lines in the GTI and copies the car into positions aligned with the parking lot lines as discussed above.

The synthetic image generator 260 may generate a synthetic image by applying the techniques discussed above to copy an OI identified in a GTI to a new position in the same GTI. The synthetic image generator 260 applies the techniques discussed above to identify contextual features for an OI, for example computer vision techniques or searching the ground truth image database 230 for contextual features related to the OI. The synthetic image generator 260 applies the techniques discussed above to identify instances of contextual features within the same GTI and copies the OI to a different position in the GTI in alignment or in relation with the identified instance of contextual features. For example, in an image of a parking lot next to a body of water, the synthetic image generator 260 identifies a car in the parking lot. To copy the car at a different position in the parking lot, the synthetic image generator 260 identifies additional instances of parking lot lines in the GTI such as a second parking lot or additional parking spaces in the same parking lot. Such additional instances represent eligible positions where the synthetic image generator 260 may copy the car. In doing so, the synthetic image generator 260 identifies portions of the GTI where the car should not be copied such as the body of water. Accordingly, the synthetic image generator 260 copies the car to one or more of the eligible positions to generate one or more synthetic images.

In some embodiments where the size threshold module 250 determines that the relative size of an OI does not exceed the threshold (e.g., is equal to or below the threshold), the synthetic image generator 260 may adjust the label description (hereafter referred to as “mask label”) of the OI, for example the center position, orientation, and/or position of the polygon vertices within the GTI to generate a synthetic image and labeling pair. As described above, objects may be manually labeled by an operator operating a graphical user interface to define a “mask label” around the object, for example a polygon or boundary around the object. In some embodiments, the polygon defines a matrix of pixels representing binary labels, for example whether the pixel of the object is within the polygon or beyond the polygon. Accordingly, an object's mask label is functionally a description of the object. As described herein, techniques implemented by the synthetic image generator 260 for generating synthetic image-label pairs by modifying only the mask label of an OI without modifying the image data of the GTI or another GTI are collectively referred to as “mask jittering.” To generate a more robust training dataset 210, the synthetic image generator 260 may perform mask jittering techniques in addition to or as an alternative to the context preserving techniques discussed above.

As described above, the mask label for an object is a polygon bounding the shape of an object within a coordinate space of a GTI. Accordingly, the synthetic image generator 260 may define it based on a set of pixels within the GTI that lie along the polygon bounding the object. Accordingly, the mask label for an object additionally characterizes the position and orientation of an object within the image. For example, in an image of a parking lot, the mask label defined for a car in the parking lot may be a polygon with four vertices.

Whereas the context preserving techniques described above alter the image data of a GTI by copying an OI into different GTI's or into a different position in the same GTI, mask jittering techniques alter points on a mask label for an OI to define an altered mask label for the OI without modifying or affecting the image data of a G. Because of the modification to the mask label for the OI, a GTI with an original mask for an OI and the same GTI with an altered mask label for the OI appear to an object identification model 220 as two distinct images even though the graphic content (image data) of the GTI remains unchanged. Accordingly, the synthetic image generator 260 may generate a synthetic image by redefining mask labels of one or more objects within a GTI. In embodiments where a GTI contains multiple objects, for example n objects, the synthetic image generator 260 may randomly alter the mask labels of up to n objects.

To perform mask jittering, the synthetic image generator 260 may generate one or more visually identical copies of an GTI. For each copy of the GTI, the synthetic image generator alters the mask label for an OI by modifying the polygon bounding the OI by adjusting the length of an edge of the polygon by a random length, randomly adjusting the positions of the vertices of the polygon, rotating an edge of the polygon by a random degree, another other suitable change to the polygon, or a combination thereof. In one embodiment, the synthetic image generator 260 applies image manipulation/processing algorithms to change the positions of all vertices of the polygon in a coordinated way to yield a new, modified polygon. Examples of such image manipulation/process algorithms include, but are not limited to, rotation, scaling, shearing, or a combination thereof (e.g., applying an affine transformation with various parameters in the transformation matrix). For another example, the synthetic image generator 260 may apply morphological filtering and contour smoothing or sharpening algorithms to modify all vertices of the polygon surrounding an OI in a coordinated way, yielding a new modified polygon. As another example, the synthetic image generator 260 may independently move the position of each vertex of the polygon by randomly moving the vertex within a predefined radius (measured by a predefined number of pixels determined as a percentage of the length of the polygon edge including the vertex), or moved within a length (measured by a predefined number of pixels in either direction) along the edge of the polygon including the vertex. The first two example embodiments describe variations due to imaging pose, change of perspective and global human labeling error due to the use of labeling tools, whereas the third example embodiment may capture variations due to random image noises, local human labeling error due to the use of labeling tools, etc. Accordingly, the synthetic image generator 260 defines a new bounding polygon around the OI (e.g., a new mask label around the OI). Given the randomness of the distortions to polygon bounding the OI, the mask label for the OI varies in each copy of the GTI.

The synthetic image generator 260 updates the object identified training dataset with each copy of the GTI. During training, the object identification model 220 is exposed to the same OI within the same GTI multiple times with slightly varying mask labels. As a result, the object identification model 220 is trained to assign greater weights to visual features located at the center of an OI when identifying or detecting the OI.

### Context Preserving Techniques

As discussed above with regards to FIG. 2, an object identification system 130 may generate synthetic images to be added to a training dataset by copying an object of interest (OI) from one ground truth image (GTI) into a second GTI, copying an independent OI into a GTI, or moving the OI to a new position within the same GTI. Techniques for generating such synthetic images is collectively referred to as “object augmentation.” The object augmentation may be at least one of methods: random-copy-and-paste, context-preserving, and mask-jittering, depending on the determination from the size threshold module 250.

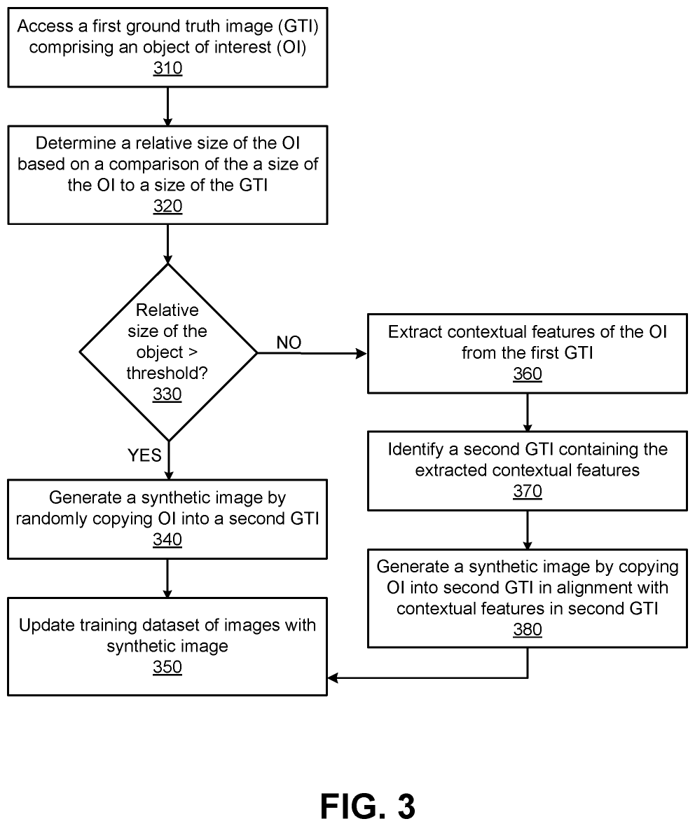

FIG. 3 is an example flowchart for applying object augmentation techniques to generate synthetic images for augmenting a training dataset, in accordance with an embodiment. An object identification system 130 accesses 310 a first GTI comprising an OI. The object identification system 130 determines 320 a relative size of the OI by comparing the size of the OI to an overall size of the GTI. The object identification system 130 determines the overall size of the GTI based on the total number of pixels in the GTI and determines the size of the OI based on the number of pixels that OI covers in the GTI. Accordingly, the object identification system 130 determines the relative size of the OI as a ratio of the number of pixels that the OI covers within the GTI to the total number of pixels that the OI covers within the GTI.

The object identification system 130 compares 330 the relative size of the OI to a threshold size. If the relative size of the OI exceeds the threshold size, the object identification system 130 generates 340 a synthetic image by randomly copying the OI into a second GTI (e.g., random-copy-and-paste methods). Given the relative size of the OI, the visual features of the OI are sufficient for an object identification model to detect and identify the OI regardless of the context or scene surrounding the OI. Accordingly, the object identification module 130 may generate a synthetic image by randomly selecting the second GTI from a dataset and copy the OI into the second GTI at a random position and/or orientation. Additionally, the object identification module 130 may generate a synthetic image by randomly moving the position or orientation within the same OI. The object identification model 130 updates 350 a dataset of images for training an object identification model with the generated synthetic image.

If the relative size of the OI does not exceed the threshold size, the object identification system 130 extracts 360 contextual features of the OI from the first GTI. As described above, contextual features are visual features of the GTI that provide additional insight into the identification of an OI, for example other objects or features of a scene that are commonly associated with OI. The object identification system 130 identifies 370 a second GTI containing the extracted contextual features and identifies each instance of the contextual features present in the second GTI. The object identification system 130 generates 380 a synthetic image by copying the OI into the second GTI in alignment with the contextual features of the second GTI (e.g., context-preserving techniques). For example, if the OI is a car and the contextual features are a parking lot lines, the object identification system 130 copies the OI at a position and orientation consistent with how a car would park between the parking lot lines. The object identification model 130 updates 350 a dataset of images for training an object identification model with the generated synthetic image.

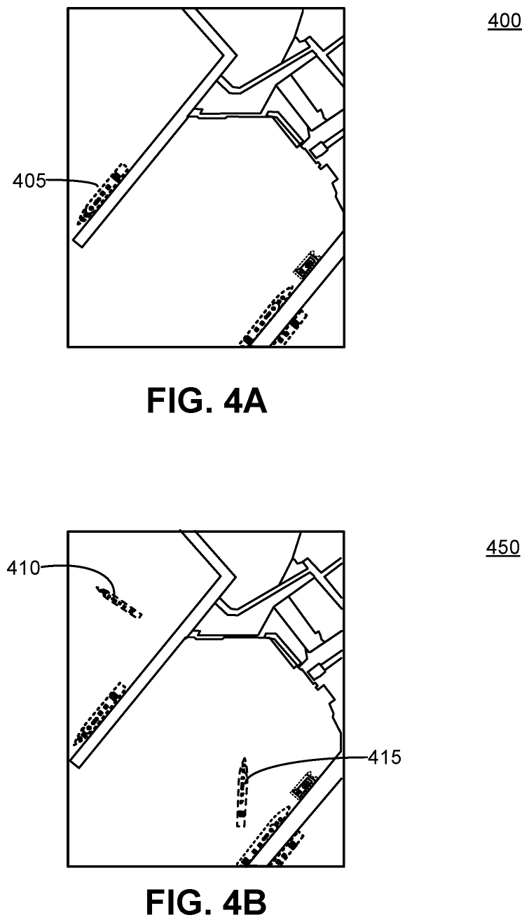

FIG. 4A illustrates an example ground truth image containing a large object of interest, in accordance with an embodiment. For the sake of explanation, “large objects of interest” are those whose relative size exceeds a threshold size. The ground truth image 400 is a scene of a pier surrounded by a body of water. The GTI 400 contains an OI 405 (a boat) in addition to other others which are not of interest (not labeled) such as other boats or vehicles on land. When generating synthetic images, the object identification module 130 may apply an algorithm to randomly select up to n objects from a GTI containing multiple objects to be copied into the same or a different GTI. Each copy of the object is subject to random distortion when copied to a new position or a new image. In the image illustrated in FIG. 4A, the object size module 240 selected a single OI 405.

FIG. 4B illustrates an example synthetic image generated by moving the position of the large object of interest within the ground truth image, in accordance with an embodiment. The object identification system 130 generates the synthetic image 450 by copying the OI into the same GTI (i.e., the GTI 400) at random positions and orientations to create copies of the OI 410 and 415. The object identification module 130 applies random distortion to the copies 410 and 415. Accordingly, compared to the original OI 405, the copies 410 and 415 may be rotated, scaled in the x-direction, y-direction, or both, altered in their color or contrast, or a combination thereof. In some embodiments, the object identification system 130 randomly scales an OI in the x-direction or the y-direction, but in other embodiments the object identification system 130 or a manual operator defines the boundaries for such scaling based on an analysis of the entire GTI database or a subset of the OIs in the GTI database. Although the placement of the copies 410 and 415 can be random given the relative size of the OI 405, an operator may supply instructions, for example as input to a graphical user interface, for the object identification system 130 to limit the placement of the copies to the body of water captured in the scene 405. The object identification system 130 may executed the supplied instructions by applying an algorithm capable of identifying pixels representing the body of water in the GTI (e.g., a semantic segmentation algorithm or an algorithm extracting metadata from a digital map), accessing a stored rule indicating “where an OI is a boat, the OI can only be copied to regions or subsets of pixels representing water,” and copying the OI at a position according to the accessed rule.

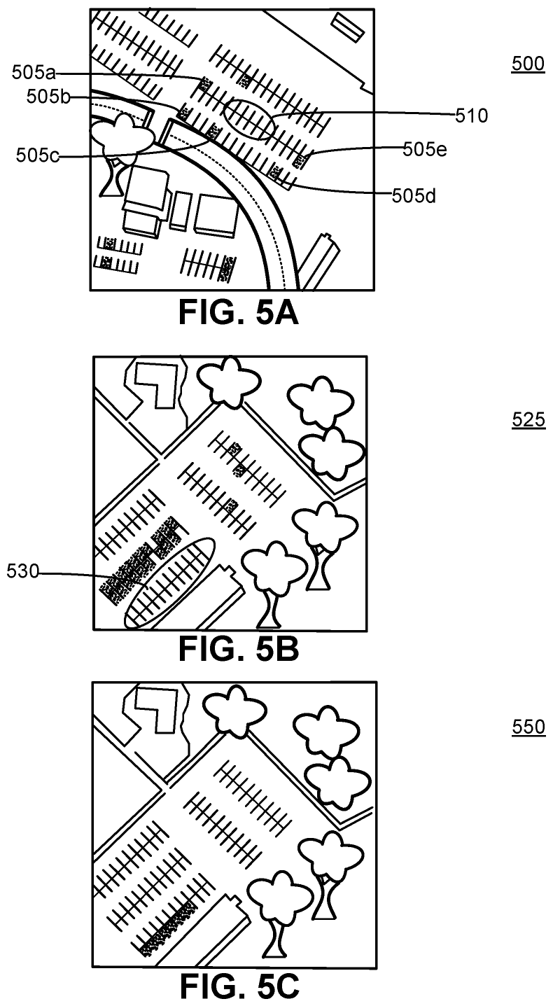

FIG. 5A illustrates an example first ground truth image containing multiple small objects of interest, in accordance with an embodiment. For the sake of explanation, “small objects of interest” are those whose relative size is below a threshold size. The first ground truth image 500 is a scene of a parking lot with multiple parked cars. The object identification system 130 selects a subset of the parked cars (e.g., the cars 505a, 505b, 505c, 505d, 505e) to be copied into a second GTI to generate a synthetic image. As discussed above, the object identification module 130 extracts contextual features for a small OI to assist in the detection and placement of the OI in the second GTI. Accordingly, the object identification system 130 additionally identifies contextual features 510 within the first GTI 500, which represent parking lot lines within which the vehicles in the parking lot are positioned.

FIG. 5B illustrates an example second ground truth image sharing contextual features with the first ground truth image, in accordance with an embodiment. The second ground truth image 525 is a scene of an alternate parking lot. The object identification system 130 identifies the second GTI 525 by searching an image database for other images containing the contextual features 510 identified in the first GTI 500. After identifying the second GTI 525, the object identification system 130 identifies a sub-region within the second GTI 525 containing the contextual features using an image processing algorithm. In the illustrated embodiment of FIG. 5B, the sub-region 530 contains parking lot lines resembling the features 510 in the first GTI 500.

FIG. 5C illustrates an example synthetic ground truth image generated by augmenting the second ground truth image with the one or more small objects of interest from the first ground truth image, in accordance with an embodiment. When copying the OI's 505a, 505b, 505c, 505d, and 505e into positions in the sub-region 530 to generate a synthetic image, the object identification system 130 places each OI at a position and orientation that aligns with the contextual features identified in the region 530. For example, each OI 505 is positioned between to and parallel with a pair of parking lot lines just as a properly parked car would be. In some embodiments, the object identification system 130 may considers the placement and pattern of other objects in the second GTI and mimic the placement pattern of those other objects when copying the OI's 505a, 505b, 505c, 505d, and 505e into the sub-region 530. For example, the object the identification system 130 may copy the OI's 505a, 505b, 505c, 505d, and 505e into the sub-region 530 in a manner consistent with the placement pattern of other parked cars in the sub-region 530 and/or other sub-regions of the parking lot in the second GTI 525. In some embodiments, each of the OI's 505 is distorted when copied into positions of the sub-region 530, but the object identification system 130 controls the scaling of each OI to mimic the size of other similar objects in the second GTI (e.g., other parked cars). In this manner, the object identification system 130 generates the synthetic image 550 by copying OI's 505 from the first GTI 510 to particular positions of sub-region 530 of the second GTI 525. For the sake of illustration, each copied OI 505 is outlined by a polygon in the illustrated embodiment of the FIG. 5C.

### Mask Jittering

As discussed above with regards to FIG. 2, an object identification system 130 may generate synthetic images to be added to a training dataset by altering a mask label for an object of interest (OI) in a ground truth image. Techniques for altering such mask labels are collectively referred to as “mask jittering.” A mask label for an object in an image describes the geometry, position, and orientation of an object within an image. Accordingly, a mask label may be represented and interpreted as a polygon bounding an object, for example a polygon with four vertices outlining a parked car. The mask label for an object is defined manually by an operator via a graphical user interface.

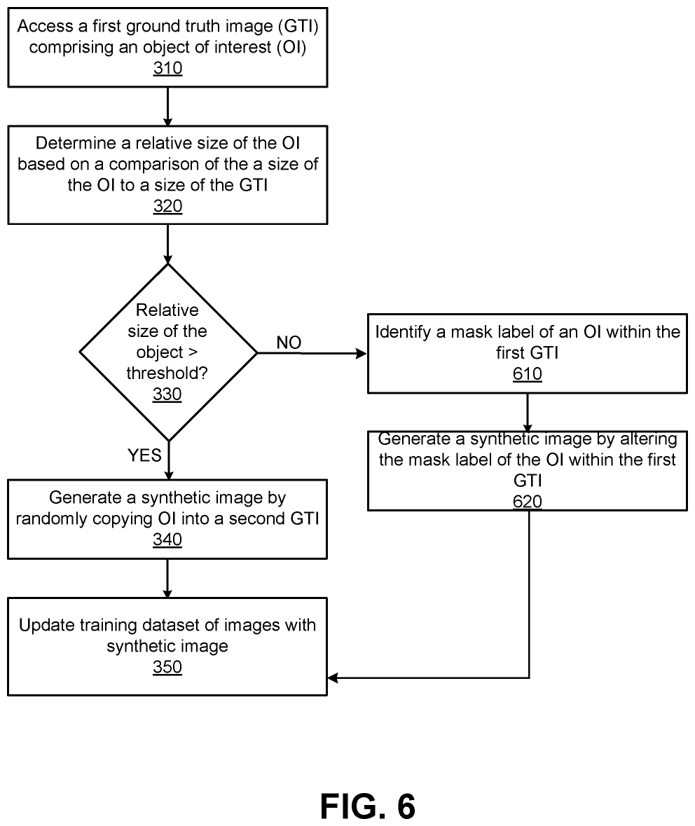

Continuing from the example flow chart illustrated in FIG. 3, FIG. 6 is an example flowchart for applying mask jittering techniques to generate synthetic images for augmenting a training dataset, in accordance with an embodiment. Where the relative size of an OI does not exceed the threshold size, the object identification system 130 may identify 610 a mask label for an object within the first GTI. The object identification system 130 generates 620 a synthetic image by altering the mask label of the OI within the first GTI. Recalling and continuing from the description of mask jittering techniques with regards to FIG. 2, The object identification system 130 may alter the mask label of the OI by modifying edges or points on the polygon defined by the mask label by a random percentage length or a random percentage rotation. Although visually and graphically the first GTI remains unchanged, an object identification model identifies an OI with an original mask label as different than an OI with an altered mask label. Accordingly, a GTI with an altered mask label around an OI is a synthetic image, which may be used to update a training dataset of images.

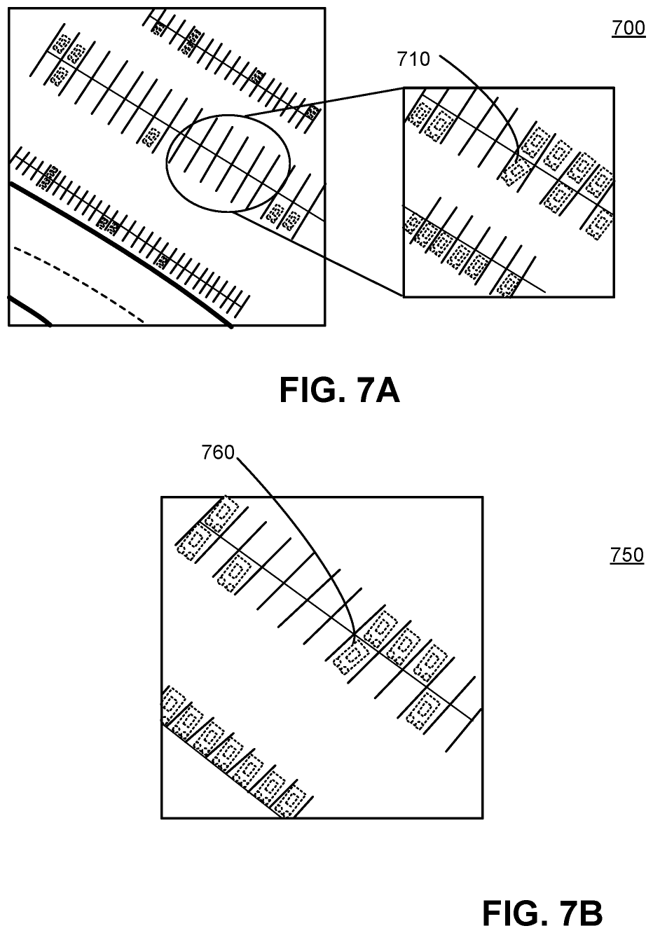

FIG. 7A illustrates an example ground truth image containing multiple small objects of interest, in accordance with an embodiment. The ground truth image 700 is a scene of parking lot with multiple parked cars. For a particular OI (e.g., a parked car), the object identification system 130 receives a mask label 710 defined by an operator. As illustrated in FIG. 7A, the mask label is a four-vertex polygon outlining the OI 710. Other objects in the region 710 may also be assigned mask labels but may not be considered by the object identification system 130. FIG. 7B illustrates an example synthetic ground truth image generated by altering a mask label for one or more of the small objects of interest from the ground truth image, in accordance with an embodiment. As discussed above, the altering a mask label involves modifying the polygon bounding the OI, for example by adjusting the length of one or more edges of the polygon or rotation angles of the polygon. In some embodiments, a mask label may be altered by moving each vertex and/or vertex pair on the polygon bounding an object. In the illustrated embodiment of FIG. 7B, the object identification system 130 defines an altered mask label 760 by adjusting both the angles and lengths of edges of the mask label 710. Although the altered mask label 760 is also a four-vertex polygon, it is geometrically distinct from the mask label 710. Given the geometric distinctiveness of the altered mask label 760, the synthetic image 750 defines the OI based on a different set of pixels (those within the altered mask label 760) than the original set of pixels representing the OI (those within the mask label 710). Accordingly, the synthetic image 750 generated by modifying the mask label 710 is used to augment a training dataset.

Because mask labels are defined manually by operators and may carry human errors in their definition, synthetic images generated by altering mask labels enables an object identification model to be trained to account for such human error. During training, an object identification model learns to assign greater weight (e.g., importance) to pixels and visual features located at the center of a mask label compared to pixels and visual features located near the edges of the mask label.

### Example Machine Architecture

FIG. 8 is a block diagram illustrating components of an example machine able to read instructions described as processes herein from a machine-readable medium and execute them in at least one processor (or controller). Specifically, FIG. 8 shows a diagrammatic representation of a machine in the example form of a computer system 800. The computer system 800 can be used to execute instructions 824 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment. It is noted the instructions correspond to the functionality of components and/or processes described herein, for example, with respect to FIGS. 1-7B.

The machine may be a server computer, a client computer, a personal computer (PC), a tablet PC, a set-top box (STB), a smartphone, an internet of things (IoT) appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processing units (generally processor 802). The processor 802 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 800 also includes a main memory 804. The computer system may include a storage unit 816. The processor 802, memory 804 and the storage unit 816 communicate via a bus 808.

In addition, the computer system 800 can include a static memory 806, a display driver 810 (e.g., to drive a plasma display panel (PDP), a liquid crystal display (LCD), or a projector). The computer system 800 may also include alphanumeric input device 812 (e.g., a keyboard), a cursor control device 814 (e.g., a mouse, a trackball, a joystick, a motion sensor, or other pointing instrument), a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 may be transmitted or received over a network 526 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store the instructions 824. The term “machine-readable medium” shall also be taken to include any medium that is capable of storing instructions 824 for execution by the machine and that cause the machine to perform any one or more of the methodologies disclosed herein. The term “machine-readable medium” includes, but not be limited to, data repositories in the form of solid-state memories, optical media, and magnetic media. It is noted that in some example embodiments, the core components of the computer system may disregard components except for the processor 802, memory 804, and bus 808 and may in other embodiments also include the storage unit 816 and/or the network interface device 820.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated and described with FIGS. 1-4. Modules may constitute either software modules (e.g., code embodied on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 802, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the claimed invention. This description should be read to include one or at least one and the singular also includes the plural unless it is obvious that it is meant otherwise.

Upon reading this disclosure, those of skill in the art will appreciate still additional alternative structural and functional designs for a system to estimate a population estimate of an AOI. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A non-transitory computer readable storage medium comprising stored instructions encoded thereon that, when executed by one or more processors, cause the processors to:
access a first ground truth image comprising an object of interest (OI);
determine a relative size of the OI based on a comparison of a size of the OI to an overall size of the first ground truth image;
generate, responsive to determining that the relative size of the OI does not exceed the threshold size, a synthetic image by copying the OI into a second ground truth image, the second ground truth image different from the first ground truth image; and
update a training dataset of images with the synthetic image, wherein the training dataset is applied to train a machine-learned model to identify the OI in an image of a test dataset.

2. The non-transitory computer readable storage medium of claim 1, wherein the instructions to determine the relative size of the object further comprise stored instructions that when executed cause the processors to:
determine the size of the OI based on a number of pixels of the first ground truth image covered by the OI;
determine the overall size of the ground truth image based on a total number of pixels in the ground truth image; and
determine the relative size of the OI based on a ratio of the number of pixels covered by the OI to the total number of pixels in the first ground truth image.

3. The non-transitory computer readable storage medium of claim 1, wherein the threshold size is determined based on one of the following:
an input size of the machine-learned model; and
an overall size of the first ground truth image, the overall size of the ground truth image determined based on a total number of pixels in the ground truth image.

4. The non-transitory computer readable storage medium of claim 1, wherein the instructions to generate the synthetic image by copying the OI into a second ground truth image further comprise stored instructions that when executed cause the processors to:
extract a contextual feature of an OI by applying an image processing technique to the first ground truth image, wherein the contextual feature enables the machine-learned model to identify the OI;
search a database of ground truth images for one or more candidate ground truth images containing the extracted contextual feature; and
select the second ground truth image from the one or more candidate ground truth images; and
generate the synthetic image by copying the OI to a position in the second ground truth image based on a position of the contextual feature in the second ground truth image.

5. The non-transitory computer-readable storage medium of claim 4, wherein the instructions to copy the OI to the position in the second ground truth image further comprise stored instructions that when executed cause the processors to:
align the OI within the contextual feature in the second image; and
orient the OI relative to the contextual feature based on a pattern of positions of other objects relative to the contextual feature.

6. The non-transitory computer readable storage medium of claim 4, wherein the instructions further comprise stored instructions that when executed cause the processors to:
update the training dataset of images with the contextual feature, wherein the contextual feature is stored in the training dataset with a label mapping the contextual feature to the OI.

7. The non-transitory computer readable storage medium of claim 1, wherein the instructions further comprise stored instructions that when executed cause the processors to:
generate, responsive to a determination that the relative size of the object is below the threshold size, the synthetic image by copying the OI from an original position in the first ground truth image to an updated position in the first ground truth image, wherein the original position is different from the updated position; and
update the training dataset of images to include the synthetic image.

8. The non-transitory computer readable storage medium of claim 1, wherein the instructions further comprise stored instructions that when executed cause the processors to:
identify, responsive to a determination that the relative size of the object is below the threshold size, a mask label for the OI stored in the first ground truth image, wherein the mask label is a polygon outlining the OI defined by an operator;
generate one or more synthetic images by altering the mask label in the first ground truth image, wherein altering the mask label comprises:
modifying positions of one or more vertices of the polygon to adjust a length of an edge of the polygon
modifying positions of one or more vertices of the polygon to rotate an edge of the polygon; and
update the training dataset of images with the one or more synthetic images.

9. The non-transitory compute readable storage medium of claim 8, wherein the machine-learned model is trained based on the one or more synthetic images to identify the OI based on pixels located centrally to the polygon outlining the OI.

10. The non-transitory computer readable storage medium of claim 1, wherein the instructions further comprise stored instructions that when executed cause the processors to:
generate, responsive to determining that the relative size of the object exceeds the threshold size, a synthetic image by copying the OI to a random position in the second ground truth image or a random position in the first ground truth image; and
update the training dataset of images with the synthetic image.

11. A method comprising:
accessing a first ground truth image comprising an object of interest ((ill);
determining a relative size of the OI based on a comparison of a size of the OI to an overall size of the first ground truth image;
responsive to determining that the relative size of the OI does not exceed the threshold size, generating a synthetic image by copying the OI into a second ground truth image, the second ground truth image different from the first ground truth image; and
updating a training dataset of images with the synthetic image, wherein the training dataset is applied to train a machine-learned model to identify the OI in an image of a test dataset.

12. The method of claim 11, further comprising:
determining the size of the OI based on a number of pixels of the first ground truth image covered by the OI;
determining the overall size of the ground truth image based on a total number of pixels in the ground truth image; and
determining the relative size of the OI based on a ratio of the number of pixels covered by the OI to the total number of pixels in the first ground truth image.

13. The method of claim 11, wherein the threshold size is determined based on one of the following:
an input size of the machine-learned model; and
an overall size of the first ground truth image, the overall size of the ground truth image determined based on a total number of pixels in the ground truth image.

14. The method of claim 11, wherein generating the synthetic image by copying the OI into a second ground truth image further cause the processor to:
extracting a contextual feature of an OI by applying an image processing technique to the first ground truth image, wherein the contextual feature enables the machine-learned model to identify the OI;
searching a database of ground truth images for one or more candidate ground truth images containing the extracted contextual feature; and
selecting the second ground truth image from the one or more candidate ground truth images; and
generating the synthetic image by copying the OI to a position in the second ground truth image based on a position of the contextual feature in the second ground truth image.

15. The method of claim 14, wherein generating the synthetic image by copying the OI to the position in the second ground truth image further comprises:
aligning the OI within the contextual feature in the second image; and
orienting the OI relative to the contextual feature based on a pattern of positions of other objects relative to the contextual feature.

16. The method of claim 11, further comprising:
generating, responsive to determining that the relative size of the object is below the threshold size, the synthetic image by copying the OI from an original position in the first ground truth image to an updated position in the first ground truth image, wherein the original position is different from the updated position; and
updating the training dataset of images to include the synthetic image.

17. The method of claim 11, further comprising:
responsive to determining that the relative size of the object is below the threshold size, identifying a mask label for the OI stored in the first ground truth image, wherein the mask label is a polygon outlining the OI defined by an operator;
generating one or more synthetic images by altering the mask label in the first ground truth image, wherein altering the mask label comprises:
modifying positions of one or more vertices of the polygon to adjust a length of an edge of the polygon
modifying positions of one or more vertices of the polygon to rotate an edge of the polygon; and
updating the training dataset of images with the one or more synthetic images.

18. The method of claim 17, wherein the machine-learned model is trained based on the one or more synthetic images to identify the OI based on pixels located centrally to the polygon outlining the OI.

19. The method of claim 17, further comprising:
responsive to determining that the relative size of the object exceeds the threshold size, generating a synthetic image by copying the OI to a random position in the second ground truth image or a random position in the first ground truth image; and
updating the training dataset of images with the synthetic image.

20. A non-transitory computer readable storage medium storing instructions encoded thereon that, when executed by one or more processors, cause the processors to:
access a first ground truth image comprising an object of interest ((ill);
determine a relative size of the OI based on a comparison of a size of the OI to an overall size of the first ground truth image;
identify, responsive to determining that the relative size of the object is below the threshold size, a mask label for the OI stored in the first ground truth image, wherein the mask label is a polygon outlining the OI defined by an operator;
generate one or more synthetic images by altering the mask label in the first ground truth image, wherein altering the mask label comprises:
modifying positions of one or more vertices of the polygon to adjust a length of an edge of the polygon
modifying positions of one or more vertices of the polygon to rotate an edge of the polygon; and
update the training dataset of images with the one or more synthetic images.
